(19) United States
(12) Patent Application Publication
(10) Pub. No.: US 2007/0256305 A1
(43) Pub. Date: Nov. 8, 2007

(54) METHOD OF SEPARATING FROZEN FOOD PRODUCTS AND FROZEN FOOD PRODUCT SEPARATION TOOL

(75) Inventor: Dean Shapka, Macklin (CA)

Correspondence Address: DAVIS & BUJOLD, P.L.L.C., 112 PLEASANT STREET, CONCORD, NH, 03301, US

(73) Assignee: Niknak Innovations Inc., Macklin (CA)

(21) Appl. No.: 11/687,069

(22) Filed: Mar. 16, 2007

(30) Foreign Application Priority Data
May 4, 2006 (CA) 2549776

(51) Int. Cl. B25D 3/00

(52) U.S. Cl. 30/164.6

(57) ABSTRACT

A method of separating frozen food products and a frozen food product separation tool. A first step involves providing a tool that has a wedge mounted to a body and a hammer that slides along the body to impart a jarring impact to the wedge. A second step involves positioning an edge of the wedge where two frozen food products are joined. A third step involves sliding the hammer along the body to impart a jarring impact to the wedge, thereby driving the wedge between the two frozen food products.

This application claims priority from Canadian Application Serial No. 2,549,776 filed May 4, 2006.

### FIELD

The present application relates to a method of separating frozen food products, such as steaks or meat patties and a tool that is used to separate frozen food products in accordance with the method.

### BACKGROUND

U.S. Pat. No. 3,780,436 (Pellman 1973) is entitled “Device to cut or separate masses of frozen food”. U.S. Pat. No. 5,899,133 (Halladay et al 1999) is entitled “Frozen hamburger patty separator”.

### SUMMARY

According to one aspect there is provided a method of separating frozen food products. A first step involves providing a tool that has a wedge mounted to a body and a hammer that slides along the body to impart a jarring impact to the wedge. A second step involves positioning an edge of the wedge where two frozen food products are joined. A third step involves sliding the hammer along the body to impart a jarring impact to the wedge, thereby driving the wedge between the two frozen food products.

According to another aspect there is provided a frozen food product separation tool, which includes a wedge mounted to a body. A hammer is provided which is adapted to slide along the body to impart a jarring impact to the wedge.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a frozen food product separation tool.

FIG. 2 is a front elevation view of the frozen food product separation tool illustrated in FIG. 1 with hammer up.

FIG. 3 is a front elevation view of the frozen food product separation tool illustrated in FIG. 1 with hammer down.

FIG. 4 is a side elevation view of the frozen food product separation tool illustrated in FIG. 1 positioned where two meat patties are connected with hammer up.

FIG. 5 is a front elevation view of the frozen food product separation tool illustrated in FIG. 1 shown with hammer down in the process of separating two meat patties.

### DETAILED DESCRIPTION

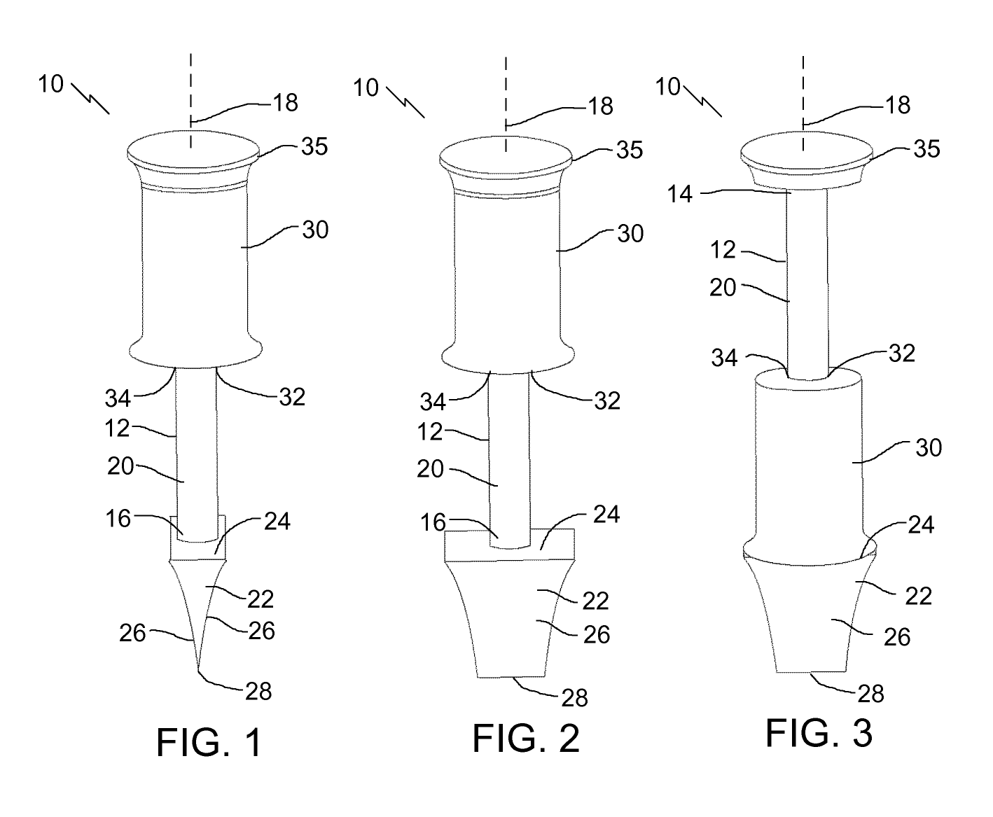

A frozen food product separation tool generally identified by reference numeral 10, will now be described with reference to FIG. 1 through 5.

Structure and Relationship of Parts:

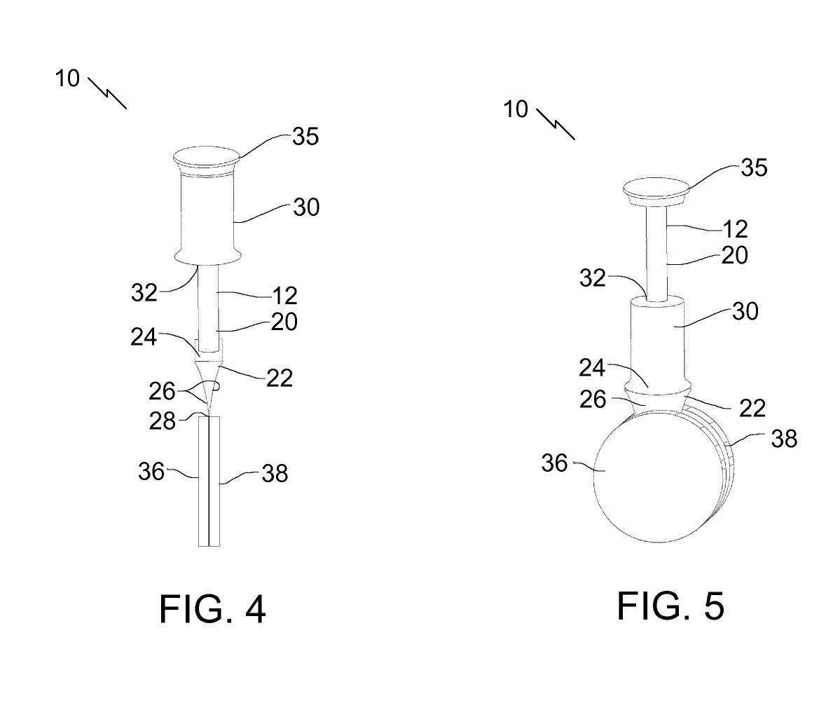

Referring to FIG. 1, frozen food product separation tool 10 includes an elongated cylindrical body 12 that has a first end 14, a second end 16 (seen in FIG. 3), an axis 18 and an exterior hammer sliding surface 20 of uniform cross-sectional dimension. A wedge 22 is mounted to and axially aligned with body 12. Wedge 22 has an anvil surface 24 and two opposed sides 26 that converge relative to each other away from anvil surface 24 to form an edge 28. Anvil surface 24 is positioned transversely in relation to second end 16 of body 12. Referring to FIG. 3, an annular hammer 30 is adapted to slide along body 12 to impart a jarring impact to anvil surface 24 of wedge 22. Referring to FIG. 2, hammer 30 has a central aperture 32 with a compatible interior profile 34 that encircles hammer sliding surface 20. A stop 35 is positioned at first end 14 of body 12, where stop 34 is adapted to prevent separation of hammer 30 from body 12. While sliding surface 20 is shown to include the entire surface between stop 34 and anvil surface 24, it will be understood that sliding surface 20 need only be provided toward second end 16, such that hammer 30 be able to strike anvil surface 24. Referring to FIG. 4 and 5, it is preferable that hammer 30 be large enough to be comfortably and securely held by one hand, such that the other hand is free to hold the frozen meat patties 36 and 38 to be separated.

Operation:

Referring to FIG. 1 through 3, frozen food product patty separation tool 10 is provided as described above. Referring to FIG. 4, edge 28 of wedge 22 is positioned where two frozen meat patties 36 and 38 are joined. Referring to FIG. 5, hammer 30 is then slid along body 12 to impart a jarring impact to wedge 22, thereby driving wedge 22 between frozen meat patties 36 and 38. Hammer 30 may be lifted toward first end 14 and slid along body 12 repeatedly if necessary until patties 36 and 38 are separated.

Variations:

It will be apparent to one skilled in the art that although the preferred form of body 12 is cylindrical with a round cross-sectional dimension, body 12 could have a different cross-sectional dimension as long as hammer 30 has a central aperture 32 with a compatible inner profile 34. It will be apparent to one skilled in the art that although wedge 22 is shown as being axially aligned with body 12; wedge 22 could be offset from body 12, as long as hammer 30 was also offset from body 12 to deliver a blow to anvil surface 24 of wedge 22.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A method of separating frozen food products, comprising the steps of:
providing a tool that has a wedge mounted to a body and a hammer that slides along the body to impart a jarring impact to the wedge;
positioning an edge of the wedge where two frozen food products are joined;
sliding the hammer along the body to impart a jarring impact to the wedge, thereby driving the wedge between the two frozen food products.

2. A frozen food product separation tool, comprising:
a wedge mounted to a body;
a hammer adapted to slide along the body to impart a jarring impact to the wedge.

3. The frozen food product separation tool as defined in claim 2, wherein the body is elongated and has a first end, a second end and an axis.

4. The frozen food product separation tool s defined in claim 3, wherein the wedge has an anvil surface and two opposed sides that converge relative to each other away from the anvil surface to form an edge, the anvil surface being positioned transversely in relation to the second end of the body.

5. The frozen food product separation tool as defined in claim 1, wherein the wedge is axially aligned with the body.

6. The frozen food product separation tool as defined in claim 1, wherein the body has an exterior hammer sliding surface of uniform cross-sectional dimension and the hammer has a central aperture with a compatible interior profile that encircles the hammer sliding surface.

7. The frozen food product separation tool as defined in claim 1, a stop being positioned at the first end of the body, the stop being adapted to prevent separation of the hammer from the body.

8. A frozen food product separation tool, comprising:
an elongated cylindrical body having a first end, a second end, an axis and an exterior hammer sliding surface toward the second end of the body;
a wedge mounted to and axially aligned with the body, the wedge having an anvil surface and two opposed sides that converge relative to each other away from the anvil surface to form an edge, the anvil surface being positioned transversely in relation to the second end of the body;
an annular hammer adapted to slide along the body to impart a jarring impact to anvil surface of the wedge, the hammer having a central aperture that encircles the hammer sliding surface.

9. The frozen food product separation toot as defined in claim 8, a stop being positioned at the first end of the body, the stop being adapted to prevent separation of the hammer from the body.
